(19) United States
(12) Patent Application Publication
(10) Pub. No.: US 2008/0129610 A1
(43) Pub. Date: Jun. 5, 2008

(54) Adaptive antenna matching for portable radio operating at VHF with single-chip based implementation

(75) Inventors: Yossi Tsfati, Rishon Letzion (IL); Gangadhar Burra, Plano, TX (US); Bruce Silverstein, Petach Tikva (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/944,900

(22) Filed: Nov. 26, 2007

Related U.S. Application Data
(60) Provisional application No. 60/868,239, filed on Dec. 1, 2006.

(51) Int. Cl. H01Q 1/50; H01Q 1/24

(52) U.S. Cl. 343/702; 343/860

(57) ABSTRACT

A novel and useful apparatus for and method of improving antenna matching and reducing mismatch loss for a VHF receiver such as an FM receiver. The invention can be used in a very low cost implementation of a single chip radio such as used in cellphone applications. The impedance of the low cost VHF antenna in cellphone application can dramatically vary across time, frequency and depending on the human body proximity resulting in a large mismatch loss. The adaptive antenna matching mechanism uses dynamically configurable on-chip variable capacitors to provide a custom matching network with the external inductor in a pi-network configuration. The variable ranges of the on-chip capacitors enable adaptation in a closed loop manner so that the optimum SNR is achieved thus ensuring minimum mismatch loss. The mechanism measures RSSI and SNR and, using a novel adaptive calibration mechanism, adjusts the internal matching network capacitors such that the mismatch loss is minimized.

### REFERENCE TO PRIORITY APPLICATION

This application claims priority to U.S. Provisional Application No. 60/868,239, filed Dec. 1, 2006, entitled “Adaptive Antenna Matching for Portable Radio Operating At VHF With Single-Chip Based Implementation”, incorporated herein by reference in its entirety.

### FIELD OF THE INVENTION

The present invention relates to the field of wireless communications and more particularly relates to an apparatus for and method of adaptive antenna matching for portable radio operating at VHF (e.g., FM receiver) with single chip based implementation.

### BACKGROUND OF THE INVENTION

Wire antennas are in widespread use in wireless communications operating in high frequency (HF) and very high frequency (VHF) bands (i.e. 50 to 100 MHz) to receive broadcast signals such as commercial broadcast FM. The wired stereo headphones that are normally used with audio devices, such as radios and multimedia devices, to listen to audio serve a secondary purpose of functioning as a wire antenna for the FM radios built into the audio devices. AC coupling of the wire antenna to the receiver circuit prevents the amplified audio signals present on the headset wire from interfering with FM radio reception.

A simplified block diagram illustrating an example prior art on-chip FM radio receiver is shown in FIG. 1. Typically, in a low cost application like a cellphone, the radio, generally referenced 10, comprises a single chip FM radio receiver 12 coupled to an antenna 14 such as a chip or wire antenna. The radio 10 comprises an, LNA 16 and RX receiver circuit 18. Note that an external fixed low pass filter can optionally be used to protect against strong channels.

For portable low cost audio devices (i.e. portable FM radios), however, the antenna impedance may vary significantly depending on the frequency and on the physical orientation of the audio device and wire antenna. This can result in a very low voltage standing wave ratio (VSWR) of as low as 1:6, for example. The low VSWR implies the existence of a high mismatch loss between the antenna and the radio which results in a significant loss of sensitivity of as low as −30 dB with an average loss of approximately −8 dB.

A diagram illustrating example non-equal antenna frequency response of a prior art radio is shown in FIG. 2. Note that the non-equal antenna gain pattern versus frequency response may cause up to 10 dB of miss antenna gain pattern in certain directions. A diagram illustrating the antenna matching (i.e. return loss or S11) versus frequency is shown in FIG. 3. Note that the best matching is achieved at a certain frequency (i.e. 100 MHz) with a return loss of better than −13 dB), while at the edge of the frequency band (i.e. 88 MHz and 108 MHz) the matching is dramatically reduced (i.e. return loss of almost 0.1 dB). It should also be noted that when a human hand is placed in close proximity to the antenna, the entire return loss response graph is shifted in the frequency domain.

Variations in antenna impedance results in variations in return loss due to close proximity of the antenna to the hand or body in the case of a chip antenna. A diagram illustrating the return loss/sensitivity versus frequency band is shown in FIG. 4. Note that the effect is exhibited when the hand of body is very close to the chip antenna (i.e. on the order of 2-4 mm). In the case of a wire antenna, twists and close proximity to the human body will cause the same effects.

A Smith chart diagram illustrating the varying antenna impedance of the prior art radio is shown in FIG. 5. Note that the optimal antenna impedance chart is a unity circle as shown in FIG. 11. This cannot be achieved, however, due to the almost −30 dB of miss match loss. A diagram illustrating the mismatch loss versus frequency is shown in FIG. 6. Note the almost 15 dB of mismatch loss variation over the FM frequency band.

The antenna impedance mismatch problem is further complicated in that a single radio device can use several different antennas each with a different antenna impedance. Further, in the case where the radio receiver is located in close proximity to a high energy source (e.g., GSM power amplifier) such as in a cell phone implementation, the high energy of the external power amplifier of the GSM radio may leak onto the ESD diodes in the integrated circuit (IC) containing the radio. The ESD diodes would not be protected in the case of an FM or VHF radio and would introduce very high energy (i.e. 18 dBm at 850 MHz meaning a voltage swing of about 1.78 V) since the LNA circuit lacks external filtering. Such a high voltage swing is above the breakdown voltage of the ESD diodes resulting in the introduction of an AM modulation effect (i.e. tones at very low frequencies in the audible frequency range with some components generated at high frequencies as well as HF, 1-2 MHz for example).

Thus, there is a need for an antenna matching circuit whose parameters can be configured based on a dynamically changing antenna impedance environment. The parameters of the matching circuit are ideally configured based on some type of feedback that is indicative of the quality of reception at that point in time.

### SUMMARY OF THE INVENTION

The present invention provides a solution to the problems of the prior art by providing an apparatus for and method of adaptive antenna matching for portable radio operating at VHF (e.g., FM receiver) with single chip based implementation. The adaptive antenna matching mechanism of the present invention is particularly suitable for use in cases where the radio receiver is implemented as a single chip with most of the matching network incorporated on-chip as well. In this case, the antenna is adapted to the radio by configuring or adapting the matching network based on measured feedback that is indicative of the quality of reception. In one example embodiment, the measured feedback includes the signal to noise ratio (SNR) and the received signal strength indication (RSSI).

Advantages of the adaptive antenna matching mechanism of the present invention include (1) providing a low cost circuit implementation that results in high efficiency and more than 10 dB is sensitivity gain; (2) the matching network permits matching the receiver to any value of antenna impedance at any frequency; and (3) the mechanism incorporates built-in filtering of blocker signals generated by the ESD diodes in the op-chip implementation.

As an example application, the adaptive antenna matching mechanism of the present invention is employed in a Digital Radio RF Processor (DRP) based transceiver. It is appreciated by one skilled in the art that the adaptive antenna matching mechanism can be similarly employed in other radio reception applications as well.

Note that many aspects of the invention described herein may be constructed as software objects that are executed in embedded devices as firmware, software objects that are executed as part of a software application on either an embedded or non-embedded computer system running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC), Field Programmable Gate Array (FPGA), logic implementation schemes including programmable devices such as PALs, PLDs, etc., or as functionally equivalent discrete hardware components.

There is thus provided in accordance with the invention, an adaptive antenna matching circuit for use in an on-chip radio comprising a plurality of varactors adapted to be coupled to an external inductor thereby forming a configurable matching network operative to provide impedance matching between an external antenna and an on-chip radio and adaptation means operative to tune the configurable parameters within the matching network so as to yield optimum signal to noise ratio (SNR).

There is also provided in accordance with the invention, an adaptive antenna matching circuit for use in a single-chip radio comprising a first varactor coupled from a first terminal to ground, the first terminal coupled to an antenna, a second varactor coupled from a second terminal to ground, the second terminal forming an output of the circuit, an inductor coupled across the first terminal and the second terminal and adaptation means for determining optimum values of the first varactor and the second varactor that maximize one or more performance criteria of the radio.

There is further provided in accordance with the invention, an adaptive antenna matching circuit for use in an on-chip radio comprising a first varactor coupled from a first pin to ground, the first pin coupled to an external antenna, a second varactor coupled from a second pin to ground, the second pin adapted to provide an output of the circuit, wherein the first pin and the second pin adapted to receive an external inductor coupled thereacross and adaptation means for determining optimum values of the first varactor and the second varactor that maximize one or more performance criteria of the radio.

There is also provided in accordance with the invention, an adaptive antenna matching circuit for use in an on-chip radio comprising a first varactor coupled from a first pin to ground, the first pin coupled to an external antenna, a second varactor coupled from a second pin to ground, a third capacitor coupled to the second pin and adapted to provide an output of the circuit, wherein the first pin and the second pin adapted to receive an external inductor coupled thereacross and adaptation means for determining optimum values of the first variable capacitor and the second variable capacitor that maximize one or more performance criteria of the radio.

There is further provided in accordance with the invention, a mobile communications device comprising a primary cellular radio, a secondary radio, a VHF radio comprising an on-chip adaptive antenna matching circuit coupled to an external antenna, the on-chip adaptive antenna matching circuit comprising a plurality of varactors adapted to be coupled to an external inductor thereby forming a configurable matching network operative to provide impedance matching between an external antenna and the on-chip VHF radio, adaptation means operative to tune the configurable parameters within the matching network so as to yield optimum signal to noise ratio (SNR) of the VHF radio, a first baseband processor coupled to the primary cellular radio and a second baseband processor coupled to the secondary radio.

### BRIEF DESCRIPTION OF THE DRAWINGS

The invention is herein described, by way of example only, with reference to the accompanying drawings, wherein:

FIG. 1 is a simplified block diagram illustrating an example prior art on-chip FM radio receiver;

FIG. 2 is a diagram illustrating example non-equal antenna gain pattern frequency response of the example prior art radio;

FIG. 3 is a diagram illustrating return loss versus frequency showing antenna matching of the example prior art antenna of FIG. 1;

FIG. 4 is a diagram illustrating the return loss/sensitivity versus frequency band;

FIG. 5 is a Smith chart diagram illustrating the varying antenna impedance of the prior art radio;

FIG. 6 is a diagram illustrating the mismatch loss versus frequency;

FIG. 7 is a block diagram illustrating a first embodiment single chip VHF radio receiver incorporating the adaptive antenna matching circuit of the present invention;

FIG. 8 is a block diagram illustrating a second embodiment single chip VHF radio receiver incorporating the adaptive antenna matching circuit of the present invention;

FIG. 9 is a block diagram illustrating a third embodiment single chip VHF radio receiver incorporating the adaptive antenna matching circuit of the present invention;

FIG. 10 is a flow diagram illustrating the matching network capacitor search and adaptation method of the present invention;

FIG. 11 is a Smith chart diagram illustrating the antenna impedance achieved using the adaptive antenna matching circuit of the present invention;

FIG. 12 is a block diagram illustrating the example ADPLL based DRP polar transmitter incorporating the adaptive antenna matching circuit of the present invention; and

FIG. 13 is a block diagram illustrating a single chip GSM radio with an integrated on-chip FM receiver incorporating the adaptive antenna matching circuit of the present invention.

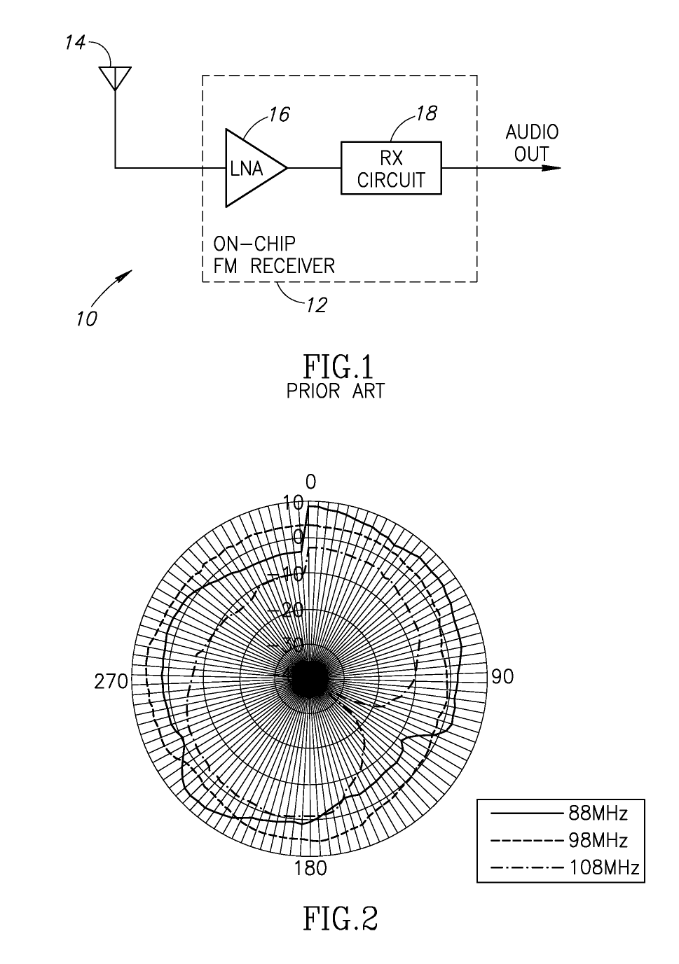

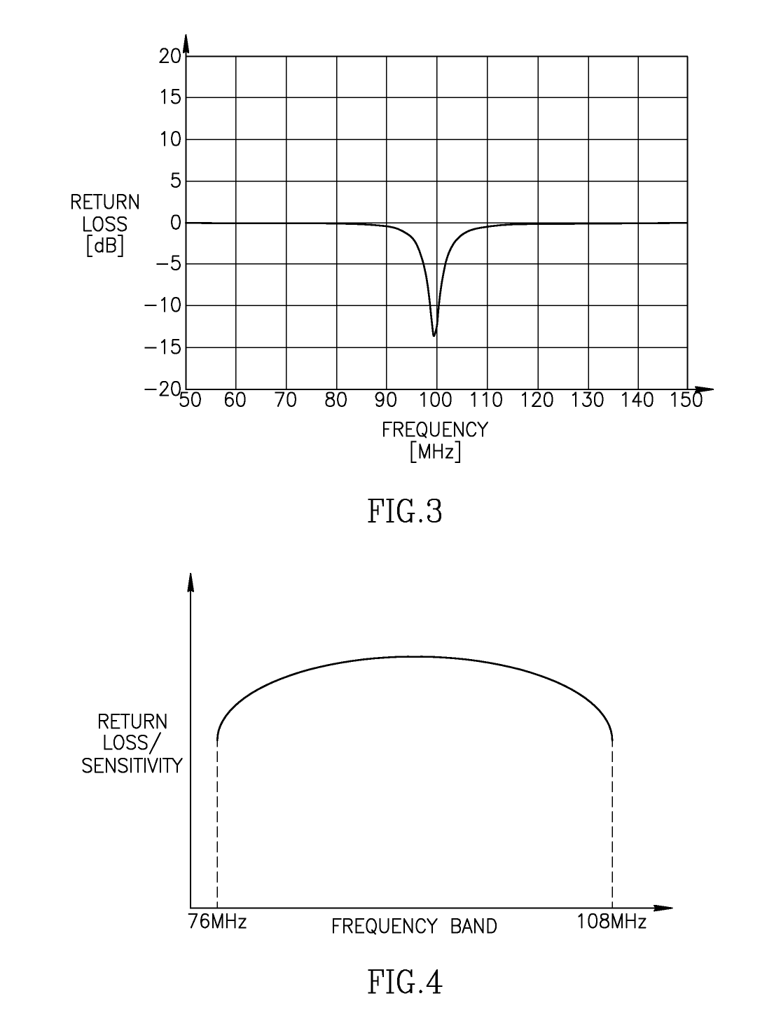

### DETAILED DESCRIPTION OF THE INVENTION

### Notation Used Throughout

The following notation is used throughout this document.

| Term | Definition |
|---|---|
| AC | Alternating Current |
| ADC | Analog to Digital Converter |
| ADPLL | All Digital Phase Locked Loop |
| AM | Amplitude Modulation |
| ARM | Advanced RISC Machine |
| ASIC | Application Specific Integrated Circuit |
| AVI | Audio Video Interface |
| BIST | Built-In Self Test |
| BMP | Windows Bitmap |
| CMOS | Complementary Metal Oxide Semiconductor |
| CPU | Central Processing Unit |
| DBB | Digital Baseband |
| DC | Direct Current |
| DCO | Digitally Controlled Oscillator |
| DCXO | Digitally Controlled Crystal Oscillator |
| DPA | Digitally Controlled Power Amplifier |
| DRP | Digital RF Processor or Digital Radio Processor |
| DSL | Digital Subscriber Line |
| DSP | Digital Signal Processor |
| EDGE | Enhanced Data Rates for GSM Evolution |
| EDR | Enhanced Data Rate |
| EEPROM | Electrically Erasable Programmable Read Only Memory |
| EPROM | Erasable Programmable Read Only Memory |
| ESD | Electrostatic Sensitive Device |
| FCW | Frequency Command Word |
| FM | Frequency Modulation |
| FPGA | Field Programmable Gate Array |
| FREF | Frequency Reference |
| GPS | Global Positioning System |
| GSM | Global System for Mobile communications |
| HDL | Hardware Description Language |
| HF | High Frequency |
| HPF | High Pass Filter |
| IC | Integrated Circuit |
| IEEE | Institute of Electrical and Electronics Engineers |
| JPG | Joint Photographic Experts Group |
| LAN | Local Area Network |
| LDO | Low Drop Out |
| LNA | Low Noise Amplifier |
| LO | Local Oscillator |
| LTE | 3GPP Long Term Evolution |
| MBOA | Multiband OFDM Alliance |
| MP3 | MPEG-1 Audio Layer 3 |
| MPG | Moving Picture Experts Group |
| OFDM | Orthogonal Frequency Division Multiplexing |
| PA | Power Amplifier |
| PAL | Programmable Array Logic |
| PAN | Personal Area Network |
| PC | Personal Computer |
| PDA | Personal Digital Assistant |
| PLD | Programmable Logic Device |
| PLL | Phase Locked Loop |
| PM | Phase Modulation |
| RAM | Random Access Memory |
| RF | Radio Frequency |
| RFBIST | RF Built-In Self Test |
| ROM | Read Only Memory |
| RSSI | Return Signal Strength Indicator |
| SAW | Surface Acoustic Wave |
| SIM | Subscriber Identity Module |
| SNR | Signal to Noise Ratio |
| SoC | System on Chip |
| SRAM | Static Read Only Memory |
| SYNTH | Synthesizer |
| TV | Television |
| UMTS | Universal Mobile Telecommunications System |
| USB | Universal Serial Bus |
| UWB | Ultra Wideband |
| VHF | Very High Frequency |
| VSWR | Voltage Standing Wave Ratio |
| WCDMA | Wideband Code Division Multiple Access |
| WiFi | Wireless Fidelity |
| WiMAX | Worldwide Interoperability for Microwave Access |
| WiMedia | Radio platform for UWB |
| WLAN | Wireless Local Area Network |
| WMA | Windows Media Audio |
| WMAN | Wireless Metropolitan Area Network |
| WMV | Windows Media Video |
| WPAN | Wireless Personal Area Network |

### DETAILED DESCRIPTION OF THE INVENTION

The present invention provides a solution to the problems of the prior art by providing an apparatus for and method of adaptive antenna matching for portable radio operating at VHF (e.g., FM receiver) with single chip based implementation. The adaptive antenna matching mechanism of the present invention is particularly suitable for use in cases where the radio receiver is implemented as a single chip with most of the matching network incorporated on-chip as well. In this case, the antenna is adapted to the radio by configuring or adapting the matching network based on measured feedback that is indicative of the quality of reception. In one example embodiment, the measured feedback includes the signal to noise ratio (SNR) and the received signal strength indication (RSSI).

To aid in understanding the principles of the present invention, the description is provided in the context of a digital RF processor (DRP) transmitter and receiver that may be adapted to comply with a particular wireless communications standard such as GSM, EDGE, Bluetooth, WLAN, WiMax, WCDMA, LTE, etc. It is appreciated, however, that the invention is not limited to use with any particular communication standard or circuit and may be used in optical, wired, wireless and control system applications. Further, the use of the invention is not limited to use with a specific modulation scheme but is applicable to any modulation scheme including both digital and analog modulation. The invention is applicable in situations where it is desirable to provide dynamic antenna impedance matching for a radio receiver (e.g., VHF receiver such as FM) implemented as a single chip based on the feedback that indicates the quality of reception.

Although the adaptive antenna matching mechanism in a PLL is applicable to numerous wireless communication standards and can be incorporated in numerous types of wireless or wired communication devices such a multimedia player, mobile station, cellular phone, PDA, DSL modem, WPAN device, etc., it is described in the context of a digital RF processor (DRP) based transmitter that may be adapted to comply with a particular wireless communications standard such as GSM, Bluetooth, EDGE, WLAN, WiMax, WCDMA, LTE, etc. It is appreciated, however, that the invention is not limited to use with any particular communication standard and may be used in optical, wired and wireless applications. Further, the invention is not limited to use with a specific modulation scheme but is applicable to any modulation scheme including both digital and analog modulation schemes.

Note that throughout this document, the term communications device is defined as any apparatus or mechanism adapted to transmit, receive or transmit and receive data through a medium. The term communications transceiver or communications device is defined as any apparatus or mechanism adapted to transmit and receive data through a medium. The communications device or communications transceiver may be adapted to communicate over any suitable medium, including wireless or wired media. Examples of wireless media include RF, infrared, optical, microwave, UWB, Bluetooth, GSM, EDGE, WiMAX, WiMedia, WiFi, 3 G/4 G or any other broadband medium, etc. Examples of wired media include twisted pair, coaxial, optical fiber, any wired interface (e.g., USB, Firewire, Ethernet, etc.). The term Ethernet network is defined as a network compatible with any of the IEEE 802.3 Ethernet standards, including but not limited to 10 Base-T, 100 Base-T or 1000 Base-T over shielded or unshielded twisted pair wiring. The terms communications channel, link and cable are used interchangeably. The notation DRP is intended to denote either a Digital RF Processor or Digital Radio Processor. References to a Digital RF Processor infer a reference to a Digital Radio Processor and vice versa. The term data frequency command word (FCW) is defined as the demanded frequency normalized by the reference frequency (FREF).

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.) and/or other content widely identified as multimedia. The user input means is typically formed of one or more manually operated switches, buttons, wheels or other user input means. Examples of multimedia devices include pocket sized personal digital assistants (PDAs), personal media player/recorders, cellular telephones, handheld devices, and the like.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

### Adaptive Antenna Matching Mechanism

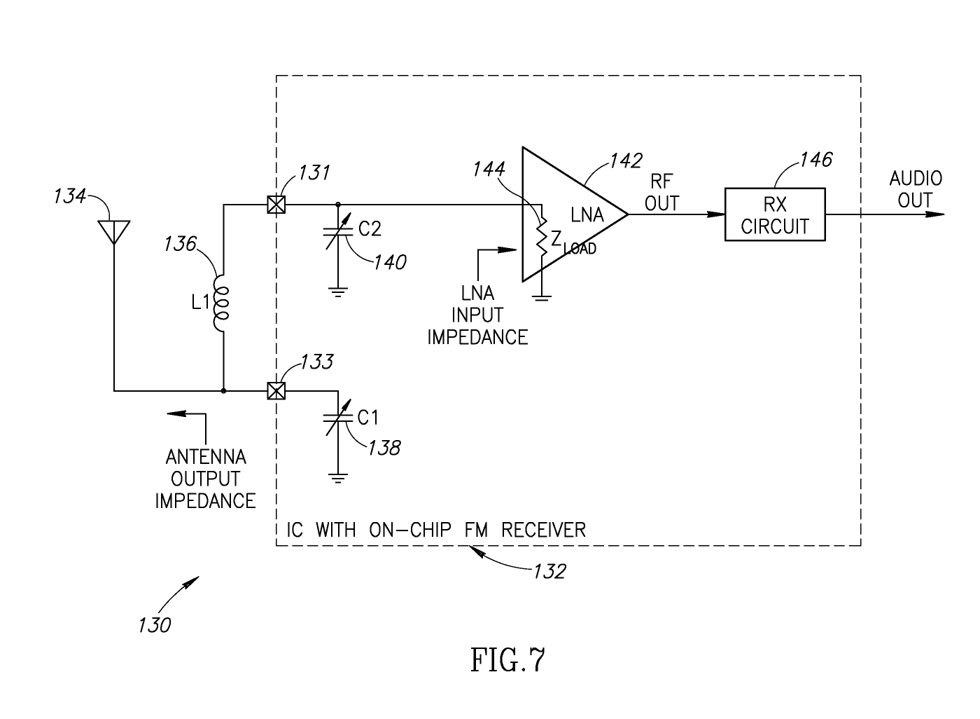

A block diagram illustrating a first embodiment single chip VHF radio receiver incorporating the adaptive antenna matching circuit of the present invention is shown in FIG. 7. The radio receiver, generally referenced 130, comprises an IC with on-chip VHF radio (i.e. FM radio) receiver 132, external inductor L1 136 and antenna 134. The on-chip FM radio circuit 132 comprises variable capacitor (i.e. varactor) C1 138 coupled to pin (terminal) 133 which is also coupled to antenna 134, varactor C2 140 coupled to pin (terminal) 131, low noise amplifier (LNA) 142 with load impedance 144 and receiver circuit 146 which functions to generate the output audio output signal. Indictor L1 136 is coupled across pins (terminals) 131, 133. Note that the dashed line represents the chip boundary wherein L1 and the antenna are off-chip and the rest of the circuit is on-chip. Note that all embodiments of the invention contemplate an adaptive matching network where any or all of the varactors and inductors are located all on-chip, all off-chip or mixed wherein some components are on-chip and others are off-chip.

In operation, the invention implements a matching network having two degrees of freedom (i.e. C1 and C2) that enable the circuit to adapt any antenna impedance to the receiver. In the example embodiment, the matching network is implemented as a PI-network within the chip wherein varactors C1 and C2 are located on-chip while inductor L1 is located off-chip. The inductor L1 is off-chip due to the receive frequency being relatively low (i.e. in the VHF frequency band, such as broadcast FM around 100 MHz). This dictates an inductor in the approximate range of 50-100 nH which would be too impractical and expensive to implement in silicon. Thus, the radio receive utilizes a PI network constructed with external inductor L1 136, single ended LNA 142 and two configurable capacitors (i.e. varactors) C1, C2.

Note that the type of antenna used is not critical to the invention. The varactors C1, C2 are configured to impedance match any type of antenna, such as wire antenna, chip antenna, ferrite stick antenna, telescopic monopole antenna, etc. The matching network functions as a wideband filter to reject out of band signals less than 88 MHz and more than 108 MHz. This is required since the LNA is not selective for FM signal frequencies. Note that in the example embodiment presented herein, a typical range for C1 and C2 is 7 to 100 pF. The mechanism for choosing the values of C1 and C2 is described in more detail infra.

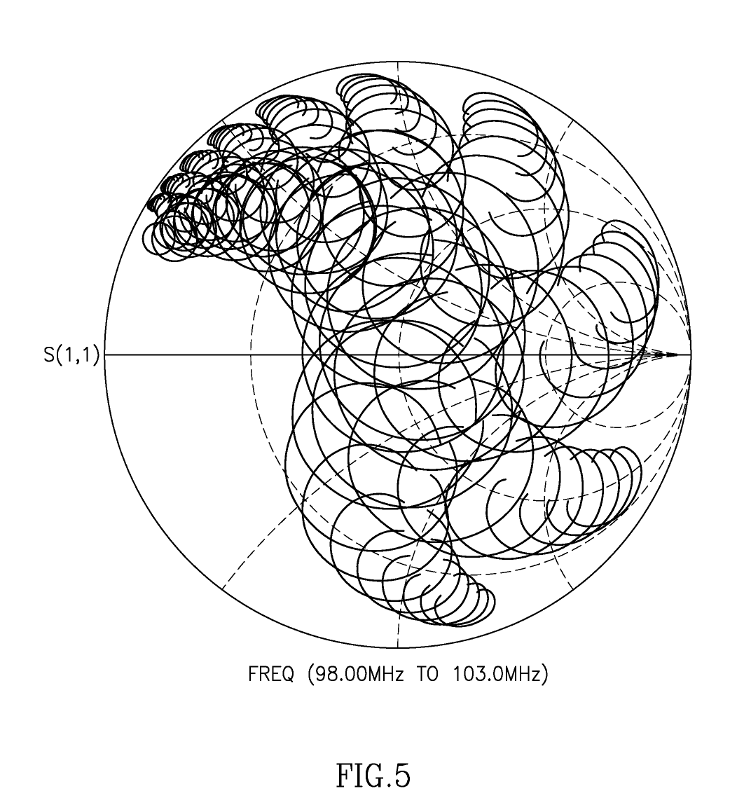

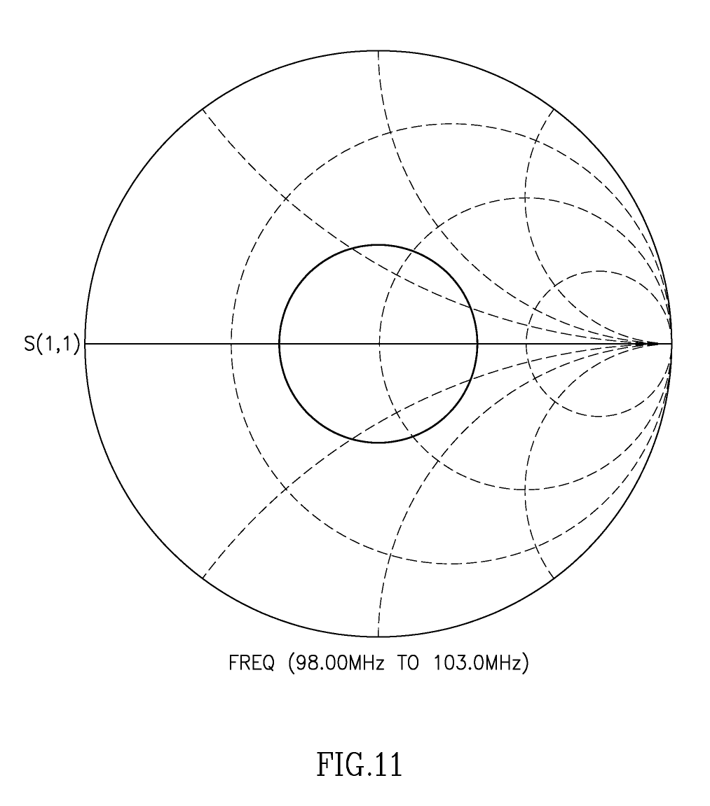

The two varactors C1, C2 function to provide two degrees of freedom in configuring the matching network to antenna impedance. Thus, any impedance of the input antenna within the smith chart of FIG. 5 can be brought and adapted to the VSWR circle of 1:2 shown in FIG. 11, thus providing a mismatch loss of less than 0.5 dB and representing a near ideal loading situation.

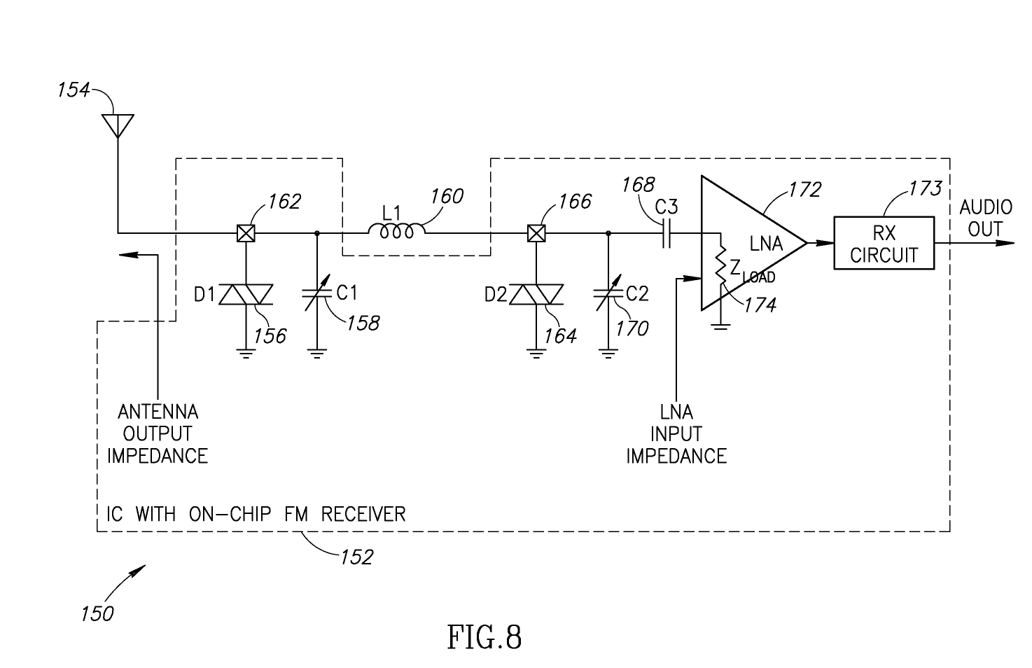

A block diagram illustrating a second embodiment single chip VHF radio receiver incorporating the adaptive antenna matching circuit of the present invention is shown in FIG. 8. The radio receiver, generally referenced 150, comprises an IC with on-chip VHF radio (i.e. FM radio) receiver 152, external inductor L1 160 and antenna 154. The on-chip FM radio circuit 152 comprises variable capacitor (i.e. varactor) C1 158 coupled to pin (terminal) 162 which is also coupled to antenna 154, varactor C2 170 coupled to pin (terminal) 166, capacitor C3 168, low noise amplifier (LNA) 172 with load impedance 174 and receiver circuit 173 which functions to generate the audio output signal. Indictor L1 160 is coupled across pins (terminals) 162, 166. Also shown are ESD diodes D1 156, D2 164 coupled to pins 162, 166 respectively. The ESD diodes (i.e. diacs or back to back zener diode equivalents) protect the chip circuitry from high voltage static discharge which would likely destroy the circuitry if not protected. Note that the dashed line represents the chip boundary wherein L1 and the antenna are off-chip and the rest of the circuit is on-chip.

In the event, the receiver is located within close proximity to a high energy source (e.g., GSM power amplifier) such as in a cell phone implementation, the high energy of the external power amplifier (PA) of the GSM radio may leak onto the ESD diodes. The diodes, not normally protected, do not have any external filtering. This would create an unwanted AM modulation effect.

In accordance with the invention, a solution to this problem is provided wherein the LNA in the radio receiver having a high pass filter (HPF) behavior. Capacitor C3 in series between pin 166 and the LNA provides the high pass filtering to remove any low frequency noise at the input such as undesirable AM modulation effects created by the high energy transmit signal leaking onto the ESD diodes. The value for C3 is typically in the same range as C1 and C2, i.e. 7 to 100 pF.

### Matching Network Adaptation Circuit and Algorithm

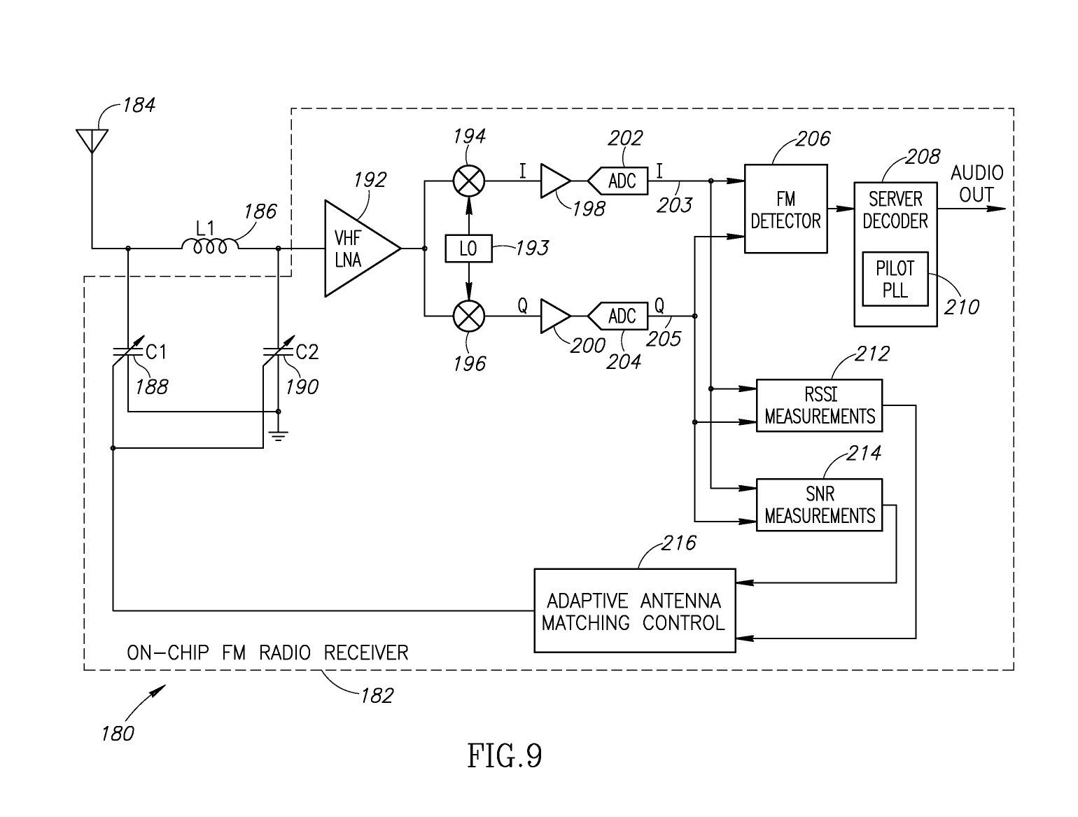

A block diagram illustrating a third embodiment single chip VHF radio receiver incorporating the adaptive antenna matching circuit of the present invention is shown in FIG. 9. Without the loss of generality, the algorithm and examples presented herein are applied to VHF-FM modulated signals. The mechanism described herein, however, may be applied to any other modulation scheme without departing from the spirit and scope of the invention. The radio receiver, generally referenced 180, comprises an on-chip radio receiver circuit 182, external inductor L1 186 and antenna 184. The radio receiver circuit 182 comprises varactors C1 188, C2 190, VHF LNA 192, local oscillator (LO) 193, I path mixer 194, baseband amplifier and filter 198, analog to digital converter (ADC) 202, Q path mixer 196, baseband amplifier and filter 200, analog to digital converter (ADC) 204, FM detector 206, stereo decoder 208 with pilot phase locked loop (PLL) 210, received signal strength indication (RSSI) measurement block 212, signal to noise ratio (SNR) measurement block 214 and adaptive antenna matching control block 216.

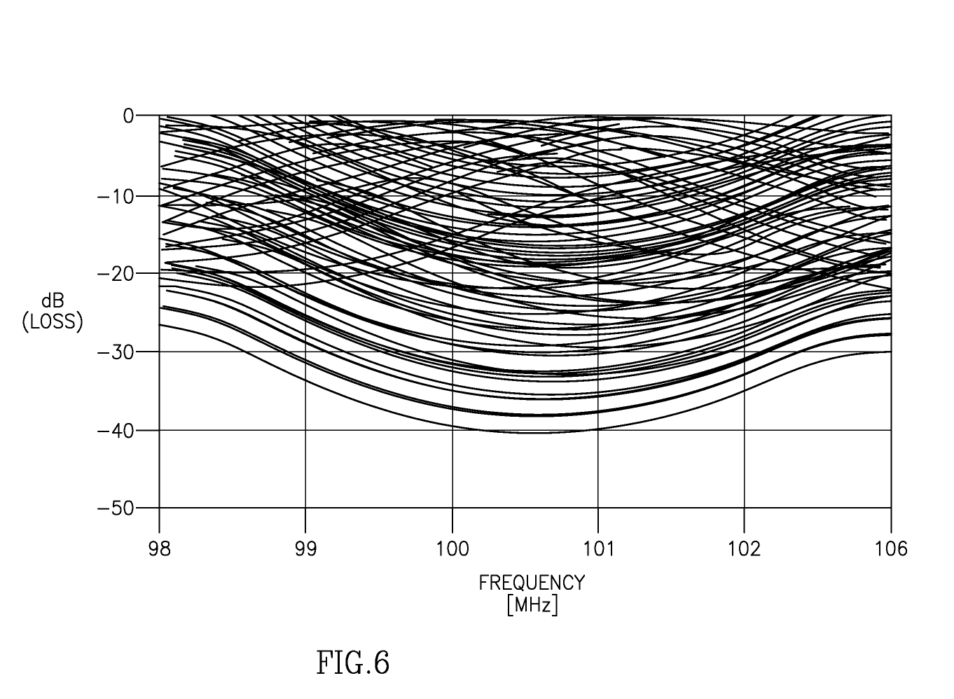

The adaptation algorithm is described in the context of the third embodiment radio receiver shown in FIG. 9. It is not intended that the adaptation described herein be limited to the example embodiments described herein. It is appreciated that the adaptation algorithm may be adapted to be implemented with numerous other radio receiver circuits as well, including the first and second embodiments shown in FIGS. 6 and 7, respectively.

In operation, the values of varactors C1, C2 are determined and configured by the adaptive antenna matching control block 216. The adaptation algorithm performed by block 216 functions to search for the best (i.e. optimum) values of C1 and C2 based on one or more performance criteria of the radio. Typically, the performance criteria include SNR and RSSI measurements. Typically, the value of L1 is set such that the adaptation algorithm is able to adapt each and every point of the smith chart, depending on the characteristic impedance of the desired input antenna.

### SNR Measurement Algorithm

In the event that the received VHF signal is modulated with an FM modulation format, an SNR measurement algorithm can be used along with an RSSI measurement to determine the signal quality which is required in the adaptation phase. When the modulated signal is other than FM, the adaptation used would rely on RSSI measurements only.

The SNR estimation algorithm for an FM modulated signal relies on the fact that an FM modulation signal has constant amplitude. Therefore, the SNR estimation is determined by taking the ratio of the variance of the amplitude of the signal expressed as

Var{R²}=Var{I²+Q²} (1)

to the signal's power given by

Mean{R²}=Mean{I²+Q²} (2)

### The SNR estimation algorithm uses the received in-phase 203 and quadrature 205 samples that are generated by the channel select baseband filter after the ADC to calculate the SNR using the following.

$$\hat{S} N R ( n ) = \frac{{\sum }_{k = 1}^{n} [ ( {I}_{( k )}^{2} + {Q}_{( k )}^{2} ) - Ps ( n ) ]}{Ps ( n )} \qquad ( 3 )$$

where Ps(n) is the estimation at time instance n and is given by:

$$Ps ( n ) = {\sum }_{k = 1}^{n} ( {I}_{( k )}^{2} + {Q}_{( k )}^{2} ) \qquad ( 4 )$$

where I(k) represents the in-phase component at time instance k, Q(k) represents the quadrature component at time instance k. Note that these values are generated by the in-phase and quadrature mixers, after being converted to the digital domain by I and Q ADCs.

### RSSI Measurement Algorithm

The Received Signal Strength Indication (RSSI) is measured using an estimation of the signal's energy. This is achieved utilizing the received in-phase and quadrature samples after passing through a channel select baseband filter. The RSSI is measured using the following equation:

$$R S S I ( n ) = \sqrt{\frac{{\sum }_{k = 1}^{n} [ {I}_{( k )}^{2} + {Q}_{( k )}^{2} ]}{n}} \qquad ( 5 )$$

where I(k) is the in-phase component at time instance k, Q(k) is the quadrature component at time instance k.

### Matching-Network Capacitor Search and Adaptation Algorithm

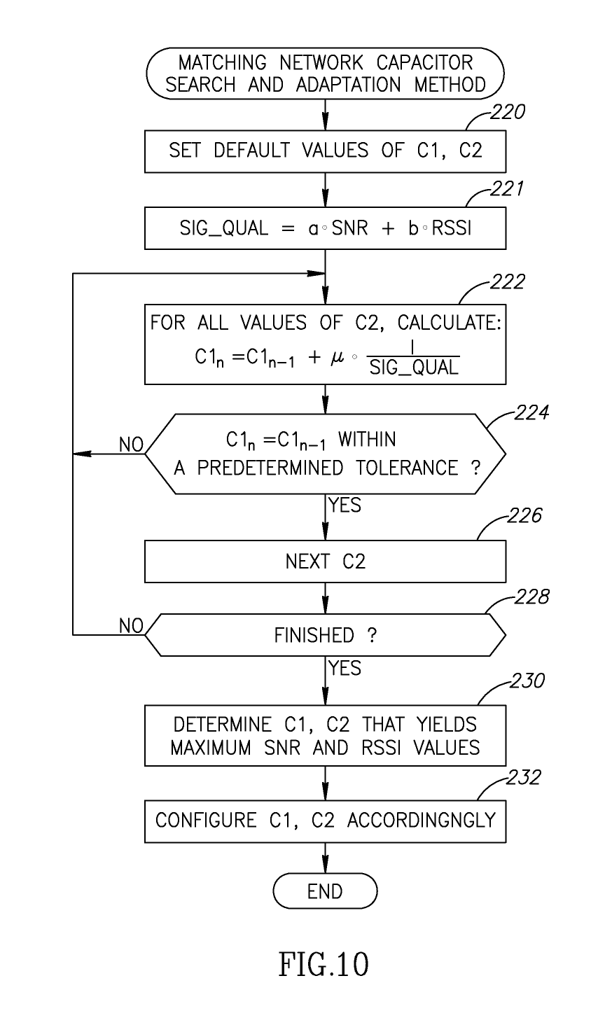

A flow diagram illustrating the matching network capacitor search and adaptation method of the present invention is shown in FIG. 10. The goal of the adaptation algorithm is to determine the best values of varactors C1 and C2 so as to maximize measured SNR and RSSI values. This can be expressed in mathematical notation as

{C1,C2}=Argmax(SNR,RSSI) (6)

The C1, C2 values are determined by first starting from default vales of C1, C2 (step 220) and calculating a value for the metric SIGqual using Equation 7 below (step 221). The method then searches until the C1, C2 values that yield maximum SNR and RSSI values are found. The following mathematical expression was created to provide a good metric for the signal quality and strength measurements:

SIGqual=(a·SNR+b·RSSI) (7)

where
a represents a coefficient expressing the value of the SNR in the search process (a practical and good implementation value may be in the order of 0.9);
b represents the coefficient that expresses the value of RSSI in the search process (a practical value of b is 0.1);

Note that in case the modulated signal is not FM modulated, the value of SIGqual will be determined only according to the measured RSSI in the inband (i.e. b=1 and a=0).

The complete search process is thus performed as follows. Given a certain value of C2, the following iteration is carried out:

$$C {1}_{( n )} = C {1}_{( n - 1 )} + μ \cdot \frac{1}{SIGqual} \qquad ( 8 )$$

where
C1(n) represents the value of capacitor C1 in the n^{th} iteration;
μ is the search coefficient step size of the iteration;
SIGqual represents the measure of signal quality of SNR and RSSI (Equation 7);

The above iteration is performed (step 222) until C1(n) is approximately equal to C1(n−1) (step 224). The process is repeated for all possible values of C2 (steps 226, 228). When all possible values of C1, C2 are exhausted, the C1, C2 values that yield the maximum SNR and RSSI values are determined (step 230). Varactors C1, C2 are then configured with the best values determined (step 232).

### Single Chip Radio

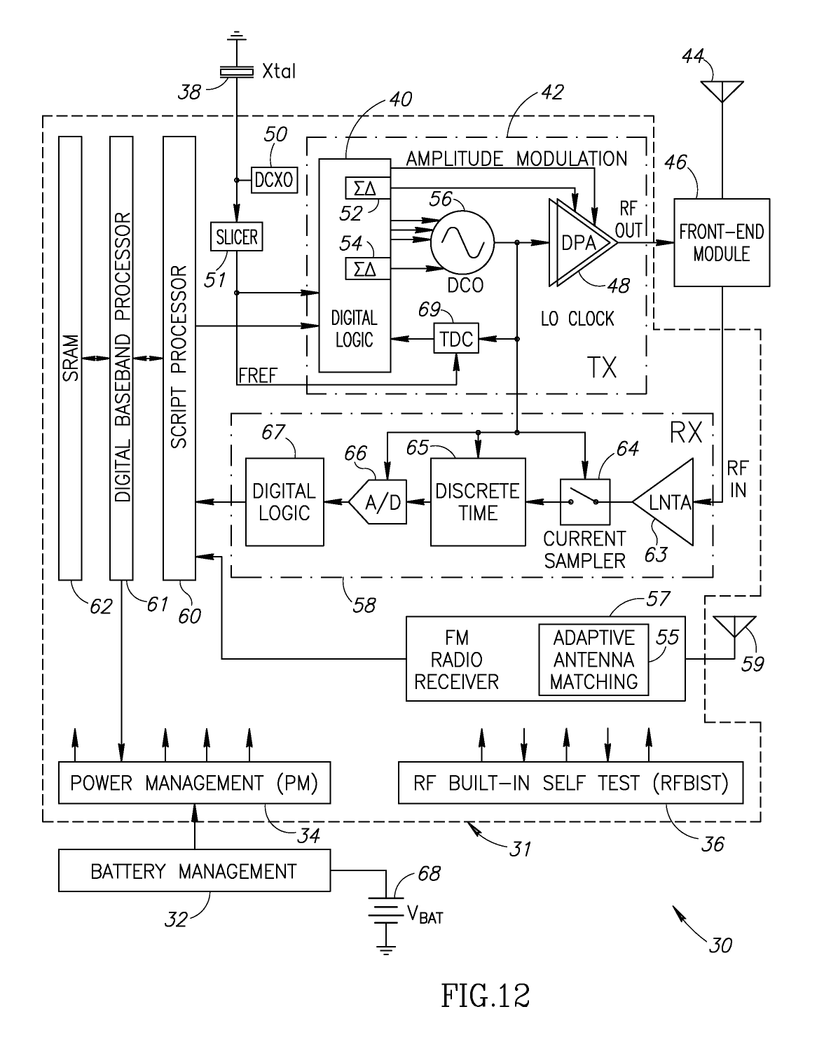

A block diagram illustrating a single chip polar transceiver radio having a VHF radio receiver incorporating the adaptive antenna matching circuit of the present invention is shown in FIG. 12. For illustration purposes only, the transceiver, as shown, is adapted for the GSM/EDGE/WCDMA cellular standards. It is appreciated, however, that one skilled in the communication arts can adapt the transceiver illustrated herein to other modulations and communication standards as well without departing from the spirit and scope of the present invention.

The radio, generally referenced 30, comprises a radio integrated circuit 31 coupled to a crystal 38, front end module 46 coupled to an antenna 44, and battery management circuit 32 coupled to battery 68. The radio chip 31 comprises a script processor 60, digital baseband (DBB) processor 61, memory 62 (e.g., static RAM), TX block 42, RX block 58, digitally controlled crystal oscillator (DCXO) 50, slicer 51, power management unit 34, RF built-in self test (BIST) 36 and FM radio receiver 57 coupled to antenna 59 and incorporating the adaptive antenna matching circuit 55 of the invention. The TX block comprises high speed and low speed digital logic block 40 including ΣΔ modulators 52, 54, digitally controlled oscillator (DCO) 56 and digitally controlled power amplifier (DPA) 48. The RX block comprises a low noise transconductance amplifier 63, current sampler 64, discrete time processing block 65, analog to digital converter (ADC) 66 and digital logic block 67.

The principles presented herein have been used to develop three generations of a Digital RF Processor (DRP): single-chip Bluetooth, GSM and GSM/EDGE radios realized in 130 nm, 90 nm and 65 nm digital CMOS process technologies, respectively. This architecture is also used as the foundation for a UMTS single-chip radio manufactured using a 45 nm CMOS process. The common architecture is highlighted in FIG. 12 with features added specific to the cellular radio. The all digital phase locked loop (ADPLL) based transmitter employs a polar architecture with all digital phase/frequency and amplitude modulation paths. The receiver employs a discrete-time architecture in which the RF signal is directly sampled and processed using analog and digital signal processing techniques.

A key component is the digitally controlled oscillator (DCO) 56, which avoids any analog tuning controls. A digitally-controlled crystal oscillator (DCXO) generates a high-quality base station-synchronized frequency reference such that the transmitted carrier frequencies and the received symbol rates are accurate to within 0.1 ppm. Fine frequency resolution is achieved through high-speed ΣΔ dithering of its varactors. Digital logic built around the DCO realizes an all-digital PLL (ADPLL) that is used as a local oscillator for both the transmitter and receiver. The polar transmitter architecture utilizes the wideband direct frequency modulation capability of the ADPLL and a digitally controlled power amplifier (DPA) 48 for the amplitude modulation. The DPA operates in near-class-E mode and uses an array of nMOS transistor switches to regulate the RF amplitude. It is followed by a matching network and an external front-end module 46, which comprises a power amplifier (PA), a transmit/receive switch for the common antenna 44 and RX surface acoustic wave (SAW) filters. Fine amplitude resolution is achieved through high-speed ΣΔ dithering of the DPA nMOS transistors.

The receiver 58 employs a discrete-time architecture in which the RF signal is directly sampled at the Nyquist rate of the RF carrier and processed using analog and digital signal processing techniques. The transceiver is integrated with a script processor 60, dedicated digital base band processor 61 (i.e. ARM family processor and/or DSP) and SRAM memory 62. The script processor handles various TX and RX calibration, compensation, sequencing and lower-rate data path tasks and encapsulates the transceiver complexity in order to present a much simpler software programming model.

The frequency reference (FREF) is generated on-chip by a 26 MHz (or any other desired frequency, such as 13 or 38.4 MHz) digitally controlled crystal oscillator (DCXO) 50 coupled to slicer 51. The output of the slicer is input to the TDC circuit 69.

An integrated power management (PM) system 34 is connected to an external battery management circuit 32 that conditions and stabilizes the supply voltage. The PM comprises multiple low drop out (LDO) regulators that provide internal supply voltages and also isolate supply noise between circuits, especially protecting the DCO. The RF built-in self-test (RFBIST) 36 performs autonomous phase noise and modulation distortion testing, various loopback configurations for bit-error rate measurements and implements the DPA calibration and BIST mechanism. The transceiver is integrated with the digital baseband, SRAM memory in a complete system-on-chip (SoC) solution. Almost all the clocks on this SoC are derived from and are synchronous to the RF oscillator clock. This helps to reduce susceptibility to the noise generated through clocking of the massive digital logic.

The transmitter comprises a polar architecture in which the amplitude and phase/frequency modulations are implemented in separate paths. Transmitted symbols generated in the digital baseband (DBB) processor are first pulse-shape filtered in the Cartesian coordinate system. The filtered in-phase (I) and quadrature (Q) samples are then converted through a CORDIC algorithm into amplitude and phase samples of the polar coordinate system. The phase is then differentiated to obtain frequency deviation. The polar signals are subsequently conditioned through signal processing to sufficiently increase the sampling rate in order to reduce the quantization noise density and lessen the effects of the modulating spectrum replicas.

A more detailed description of the operation of the ADPLL can be found in U.S. Patent Publication No. 2006/0033582A1, published Feb. 16, 2006, to Staszewski et al., entitled “Gain Calibration of a Digital Controlled Oscillator,” U.S. Patent Publication No. 2006/0038710A1, published Feb. 23, 2006, Staszewski et al., entitled “Hybrid Polar/Cartesian Digital Modulator” and U.S. Pat. No. 6,809,598, to Staszewski et al., entitled “Hybrid Of Predictive And Closed-Loop Phase-Domain Digital PLL Architecture,” all of which are incorporated herein by reference in their entirety.

### Mobile Device/Cellular Phone/PDA System

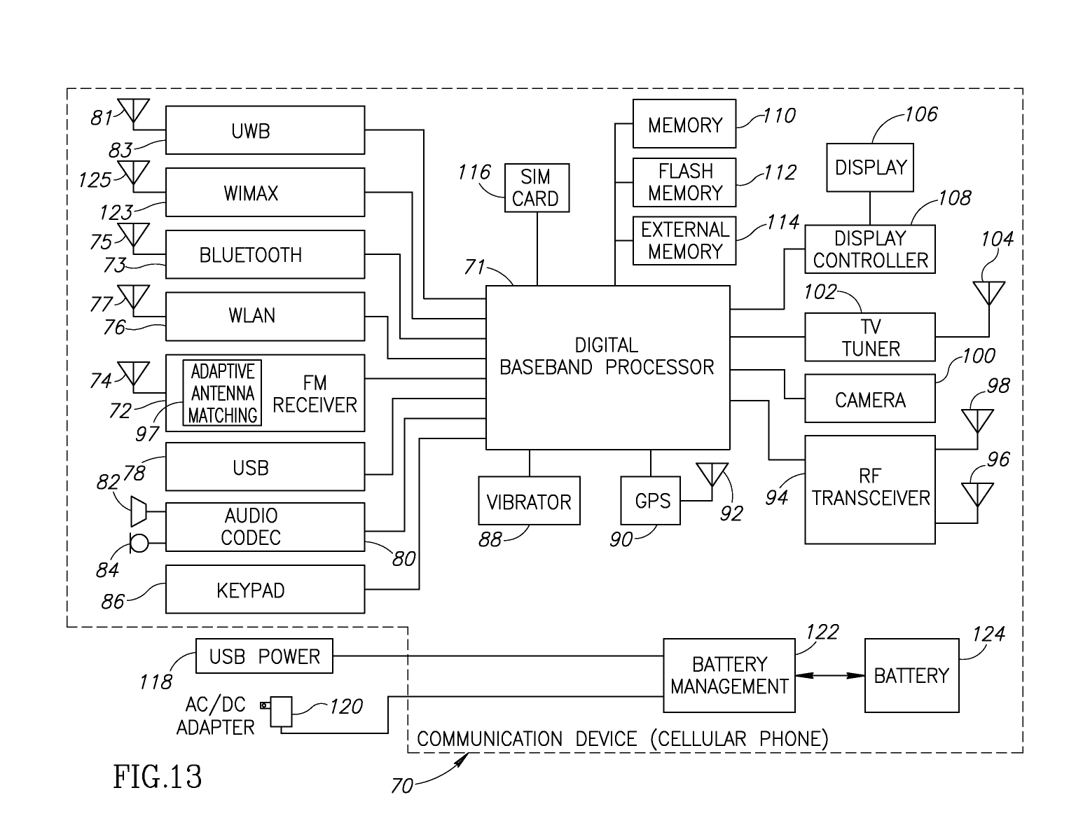

A simplified block diagram illustrating an example mobile communication device incorporating the adaptive antenna matching mechanism of the present invention is shown in FIG. 13. The communication device may comprise any suitable wired or wireless device such as a multimedia player, mobile station, mobile device, cellular phone, PDA, wireless personal area network (WPAN) device, Bluetooth EDR device, etc. For illustration purposes only, the communication device is shown as a cellular phone or smart phone. Note that this example is not intended to limit the scope of the invention as the LO generation mechanism of the present invention can be implemented in a wide variety of wireless and wired communication devices.

The cellular phone, generally referenced 70, comprises a baseband processor or CPU 71 having analog and digital portions. The basic cellular link is provided by the RF transceiver 94 and related one or more antennas 96, 98. A plurality of antennas is used to provide antenna diversity which yields improved radio performance. The cell phone also comprises internal RAM and ROM memory 110, Flash memory 112 and external memory 114.

Several user interface devices include microphone 84, speaker 82 and associated audio codec 80, a keypad for entering dialing digits 86, vibrator 88 for alerting a user, camera and related circuitry 100, a TV tuner 102 and associated antenna 104, display 106 and associated display controller 108 and GPS receiver 90 and associated antenna 92.

A USB interface connection 78 provides a serial link to a user's PC or other device. WLAN radio and interface 76 and antenna 77 provide wireless connectivity when in a hot spot or within the range of an ad hoc, infrastructure or mesh based wireless LAN network. A Bluetooth EDR radio and interface 73 and antenna 75 provide Bluetooth wireless connectivity when within the range of a Bluetooth wireless network. Further, the communication device 70 may also comprise a WiMAX radio and interface 123 and antenna 125. SIM card 116 provides the interface to a user's SIM card for storing user data such as address book entries, etc. The communication device 70 also comprises an Ultra Wideband (UWB) radio and interface 83 and antenna 81. The UWB radio typically comprises an MBOA-UWB based radio.

An FM radio receiver 72 and antenna 74 provide the user the ability to listen to FM broadcasts. In accordance with the invention, the FM radio receiver 72 comprises the adaptive antenna matching circuit 97 of the present invention. The adaptive antenna matching circuit implements a matching network with two degrees of freedom (C1 and C2) that enable adapting any antenna impedance to the receiver, as described in detail supra. In operation, the adaptive antenna matching mechanism may be implemented as hardware, as software executed as a task on the baseband processor 71 or a combination of hardware and software. Implemented as a software task, the program code operative to implement the adaptive antenna matching mechanism of the present invention is stored in one or more memories 110, 112 or 114.

Portable power is provided by the battery 124 coupled to battery management circuitry 122. External power is provided via USB power 118 or an AC/DC adapter 120 connected to the battery management circuitry which is operative to manage the charging and discharging of the battery 124.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. An adaptive antenna matching circuit for use in an on-chip radio, comprising:
a plurality of varactors adapted to be coupled to an external inductor thereby forming a configurable matching network operative to provide impedance matching between an external antenna and an on-chip radio; and
adaptation means operative to tune said configurable parameters within said matching network so as to yield optimum signal to noise ratio (SNR).

2. The circuit according to claim 1, further comprising a high pass filter operative to filter out unwanted high frequency energy leaked onto on-chip ESD diodes.

3. An adaptive antenna matching circuit for use in a single-chip radio, comprising:
a first varactor coupled from a first terminal to ground, said first terminal coupled to an antenna;
a second varactor coupled from a second terminal to ground, said second terminal forming an output of said circuit;
an inductor coupled across said first terminal and said second terminal; and
adaptation means for determining optimum values of said first varactor and said second varactor that maximize one or more performance criteria of said radio.

4. The circuit according to claim 3, wherein said one or more performance criteria comprises signal quality.

5. The circuit according to claim 3, wherein said one or more performance criteria comprises signal strength indication.

6. The circuit according to claim 3, wherein said adaptation means is operative to calculate a metric as a function of signal to noise ratio (SNR) and received signal strength indication (RSSI) measurements.

7. The circuit according to claim 3, wherein said circuit is implemented as a PI-network wherein said first varactor and said second varactor are implemented on-chip and said inductor is implemented off-chip.

8. The circuit according to claim 3, further comprising a low noise amplifier (LNA) having an input coupled to said second terminal.

9. The circuit according to claim 3, wherein said adaptation means is operative to enable said antenna matching circuit to adapt to any antenna impedance.

10. An adaptive antenna matching circuit for use in an on-chip radio, comprising:
a first varactor coupled from a first pin to ground, said first pin coupled to an external antenna;
a second varactor coupled from a second pin to ground, said second pin adapted to provide an output of said circuit;
wherein said first pin and said second pin adapted to receive an external inductor coupled thereacross; and
adaptation means for determining optimum values of said first varactor and said second varactor that maximize one or more performance criteria of said radio.

11. The circuit according to claim 10, wherein said one or more performance criteria comprises signal quality.

12. The circuit according to claim 10, wherein said one or more performance criteria comprises signal strength indication.

13. The circuit according to claim 10, wherein said adaptation means is operative to calculate a metric as a function of signal to noise ratio (SNR) and received signal strength indication (RSSI) measurements.

14. The circuit according to claim 10, wherein said circuit is implemented as a PI-network wherein said first varactor and said second varactor are implemented on-chip and said inductor is implemented off-chip.

15. The circuit according to claim 10, further comprising a low noise amplifier (LNA) having an input coupled to said second pin.

16. The circuit according to claim 10, wherein said adaptation means is operative to enable said antenna matching circuit to adapt to any antenna impedance.

17. An adaptive antenna matching circuit for use in an on-chip radio, comprising:
a first varactor coupled from a first pin to ground, said first pin coupled to an external antenna;
a second varactor coupled from a second pin to ground;
a third capacitor coupled to said second pin and adapted to provide an output of said circuit;
wherein said first pin and said second pin adapted to receive an external inductor coupled thereacross; and
adaptation means for determining optimum values of said first variable capacitor and said second variable capacitor that maximize one or more performance criteria of said radio.

18. The circuit according to claim 17, wherein said one or more performance criteria comprises signal quality.

19. The circuit according to claim 17, wherein said one or more performance criteria comprises signal strength indication.

20. The circuit according to claim 17, wherein said adaptation means is operative to calculate a metric as a function of signal to noise ratio (SNR) and received signal strength indication (RSSI) measurements.

21. The circuit according to claim 17, wherein said circuit is implemented as a PI-network wherein said first varactor and said second varactor are implemented on-chip and said inductor is implemented off-chip.

22. The circuit according to claim 17, further comprising a low noise amplifier (LNA) coupled in series with said third capacitor.

23. The circuit according to claim 17, wherein said adaptation means is operative to enable said antenna matching circuit to adapt to any antenna impedance.

24. A mobile communications device, comprising:
a primary cellular radio;
a secondary radio;
a VHF radio comprising an on-chip adaptive antenna matching circuit coupled to an external antenna;
said on-chip adaptive antenna matching circuit comprising:
a plurality of varactors adapted to be coupled to an external inductor thereby forming a configurable matching network operative to provide impedance matching between an external antenna and said on-chip VHF radio;
adaptation means operative to tune said configurable parameters within said matching network so as to yield optimum signal to noise ratio (SNR) of said VHF radio;
a first baseband processor coupled to said primary cellular radio; and
a second baseband processor coupled to said secondary radio.

25. The radio according to claim 24, further comprising a high pass filter operative to filter out unwanted high frequency energy leaked onto on-chip ESD diodes.
